(19) United States
(12) Patent Application Publication
(10) Pub. No.: US 2026/0365150 A1
(43) Pub. Date: Nov. 19, 2026

(54) BRAKE APPARATUS FOR VEHICLE

(71) Applicant: HYUNDAI MOBIS CO., LTD., Seoul (KR)

(72) Inventors: Sang Pil BOO, Yongin-si (KR); Choong Sik SHIN, Yongin-si (KR); Se Hoon AN, Yongin-si (KR); Dae Ung JEON, Yongin-si (KR)

(73) Assignee: HYUNDAI MOBIS CO., LTD., Seoul (KR)

(21) Appl. No.: 19/462,144

(22) Filed: Jan. 28, 2026

(30) Foreign Application Priority Data
May 13, 2025 (KR) 10-2025-0062059
Aug. 18, 2025 (KR) 10-2025-0114406

(51) Int. Cl. B60T 13/74; F16D 55/00; F16D 55/226; F16D 65/18; F16D 121/24; F16D 125/40

(52) U.S. Cl. CPC B60T 13/746; F16D 55/226; F16D 65/18; F16D 2055/0016; F16D 2121/24; F16D 2125/40

(57) ABSTRACT

The present disclosure relates to a brake apparatus for a vehicle, the brake apparatus including a caliper body provided with a cylinder, a piston part movably disposed in the cylinder and disposed to be opposite to a brake pad, a nut-screw part disposed in the piston part and configured to rotate by receiving a rotational force from an actuator, and a bolt-screw part including a bolt body coupled to the nut-screw part and configured to receive a rotational force from the nut-screw part, a bolt head disposed to be opposite to the piston part, and a bolt stopper configured to suppress a rotation of the nut-screw part when the bolt head is positioned at a rearmost point.

### CROSS-REFERENCE TO RELATED APPLICATION

This application claims priority from and the benefit of Korean Patent Application No. 10-2025-0062059, filed on May 13, 2025, and Korean Patent Application No. 10-2025-0114406, filed on Aug. 18, 2025, which are hereby incorporated by reference for all purposes as if set forth herein.

### BACKGROUND

### Field

The present disclosure relates to a brake apparatus for a vehicle, and more particularly, to a brake apparatus for a vehicle, the brake apparatus being capable of ensuring stable braking performance.

### Description of the Related Art

In general, a brake apparatus for a vehicle brakes a vehicle by using a frictional force between a pad and a disc by bringing the pad and the disc into contact with each other by pushing a piston by means of driving power.

Among the brake apparatuses for vehicles, an electromechanical brake (EMB) is provided with a motor-driven actuator mounted on a caliper and generates a braking force by pressing a piston by means of a mechanism, which converts a rotational motion of a screw into a rectilinear motion of a nut or converts a rotational motion of the nut into a rectilinear motion of the screw, without using hydraulic pressure.

The EMB may implement additional functions, such as anti-lock brake system (ABS), electric stability control (ESC), traction control system (TCS), and automatic emergency braking (AEB), as well as general main braking because the EMB may perform active braking and independent braking for each wheel, thereby implementing higher performance because there is no delay in transmitting hydraulic pressure.

In the related art, in case that the nut or the screw moves rearward beyond an allowable range during the rectilinear motion, the nut and the screw may be meshed with each other, which may cause an abnormal state in which a driving operation is stopped. In addition, there is a problem in that it is difficult to precisely detect the amount of abrasion of the pad because a reference position (original point) of the nut or the screw fluctuates each time a braking operation is initiated.

The background technology of the present disclosure is disclosed in Korean Patent Application Laid-Open No. 10-2024-0054695 (published on Apr. 26, 2024 and entitled ‘Brake Apparatus for Vehicle’).

### SUMMARY

An object of the present disclosure is to provide a brake apparatus for a vehicle, the brake apparatus being capable of preventing the occurrence of an erroneous operation or failure by suppressing a rotation of a nut-screw part when a bolt-screw part is positioned at a rearmost point.

An object of the present disclosure is to provide a brake apparatus for a vehicle, the brake apparatus being capable of allowing a movement of a bolt-screw part to start from an original point when a braking operation is performed.

A brake apparatus for a vehicle according to one aspect of the present disclosure includes: a caliper body provided with a cylinder; a piston part movably disposed in the cylinder and disposed to be opposite to a brake pad; a nut-screw part disposed in the piston part and configured to rotate by receiving a rotational force from an actuator; and a bolt-screw part including a bolt body coupled to the nut-screw part and configured to receive a rotational force from the nut-screw part, a bolt head disposed to be opposite to the piston part, and a bolt stopper configured to suppress a rotation of the nut-screw part when the bolt head is positioned at a rearmost point.

A nut stopper may be provided on an inner surface of the nut-screw part and protrude toward the bolt-screw part, and the bolt stopper may protrude outward further than an outer surface of the bolt head.

The bolt stopper may be disposed in a rotation route for the nut stopper and suppress a rotation of the nut stopper when the bolt head is positioned at the rearmost point, and the bolt stopper may depart from the rotation route for the nut stopper to allow the rotation of the nut stopper when the bolt head departs from the rearmost point.

The bolt stopper may include: a ring main body coupled to the outer surface of the bolt head; and a ring protrusion protruding outward from an outer surface of the ring main body and configured to come into contact with the nut stopper.

The bolt stopper may be coupled to the outer surface of the bolt head and protrude outward so as to be capable of coming into contact with the nut stopper.

The bolt stopper and the nut stopper may be respectively provided as one bolt stopper and one nut stopper.

A lateral portion of a protruding portion of the bolt stopper and a lateral portion of a protruding portion of the nut stopper may each have an inclined surface.

The bolt head may be a single member formed integrally with the bolt body.

The bolt head may be provided separately from the bolt body and integrated with the bolt body by being coupled to the bolt body.

A curved surface portion may be provided on an outer periphery of the bolt head directed toward the piston part, and the curved surface portion may be in contact with the piston part.

According to the present disclosure, the rotation of the nut-screw part may be suppressed when the bolt-screw part is positioned at the rearmost point, thereby preventing an erroneous operation or failure of the brake apparatus for a vehicle.

According to the present disclosure, the movement of the bolt-screw part starts from the original position when the braking operation is initiated, thereby preventing the occurrence of an error during the braking operation and accurately detecting the amount of abrasion of the brake pad.

### BRIEF DESCRIPTION OF THE DRAWINGS

FIG. 1 is a perspective view illustrating a brake apparatus for a vehicle according to an embodiment of the present disclosure.

FIG. 2 is a cross-sectional view schematically illustrating the brake apparatus for a vehicle according to the embodiment of the present disclosure.

FIG. 3 is a perspective view illustrating a nut-screw part and a bolt-screw part according to the embodiment of the present disclosure.

FIG. 4 is a front view illustrating the nut-screw part and the bolt-screw part according to the embodiment of the present disclosure.

FIG. 5 is an exploded perspective view illustrating the bolt-screw part according to the embodiment of the present disclosure.

FIG. 6 is a perspective view illustrating the bolt-screw part according to the embodiment of the present disclosure.

FIG. 7 is a cross-sectional perspective view schematically illustrating the brake apparatus for a vehicle according to the embodiment of the present disclosure.

FIG. 8 is a cross-sectional view illustrating the nut-screw part and the bolt-screw part according to the embodiment of the present disclosure.

FIG. 9 is a cross-sectional view illustrating a cylinder, the nut-screw part, and the bolt-screw part according to the embodiment of the present disclosure.

FIG. 10 is a perspective view illustrating a modified example of a bolt stopper of the brake apparatus for a vehicle according to the embodiment of the present disclosure.

FIG. 11 is a front view illustrating the nut-screw part and the bolt-screw part to which the modified example of the bolt stopper is applied.

FIG. 12 is a cross-sectional view schematically illustrating a brake apparatus for a vehicle according to another embodiment of the present disclosure.

FIG. 13 is a cross-sectional view schematically illustrating a modified example of a bolt stopper of the brake apparatus for a vehicle according to another embodiment of the present disclosure.

FIG. 14 is a perspective view illustrating an actuator part of the brake apparatus for a vehicle according to the embodiment of the present disclosure.

### DETAILED DESCRIPTION

Hereinafter, a brake apparatus for a vehicle will be described with reference to the accompanying drawings through various embodiments. Here, thicknesses of lines illustrated in the drawings, sizes of constituent elements, or the like may be exaggerated for clarity and convenience of description. In addition, the terms used below are defined in consideration of the functions thereof in the present disclosure and may vary depending on the intention of a user or an operator or a usual practice. Therefore, the definition of the terms should be made based on the entire contents of the present specification.

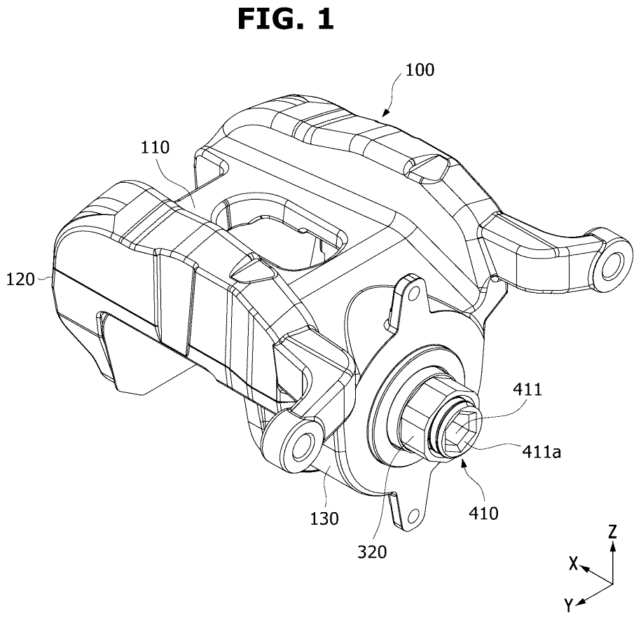

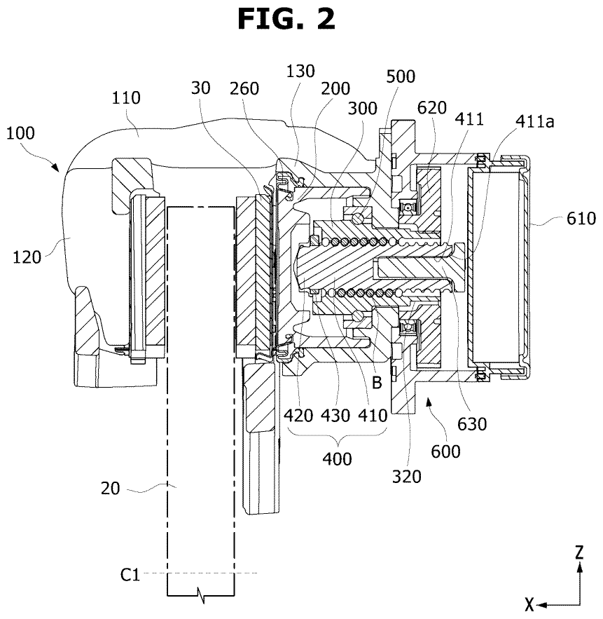

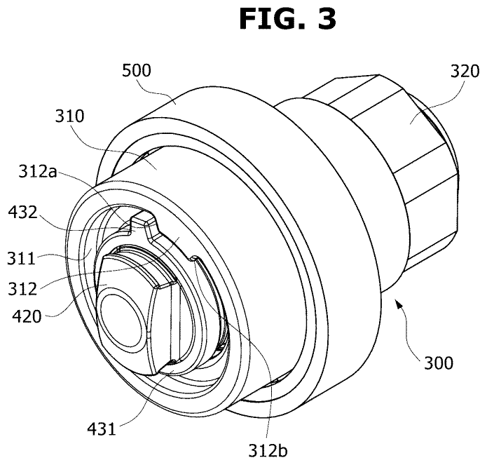

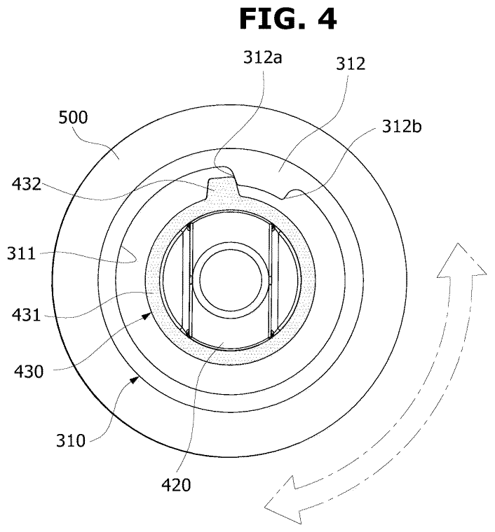

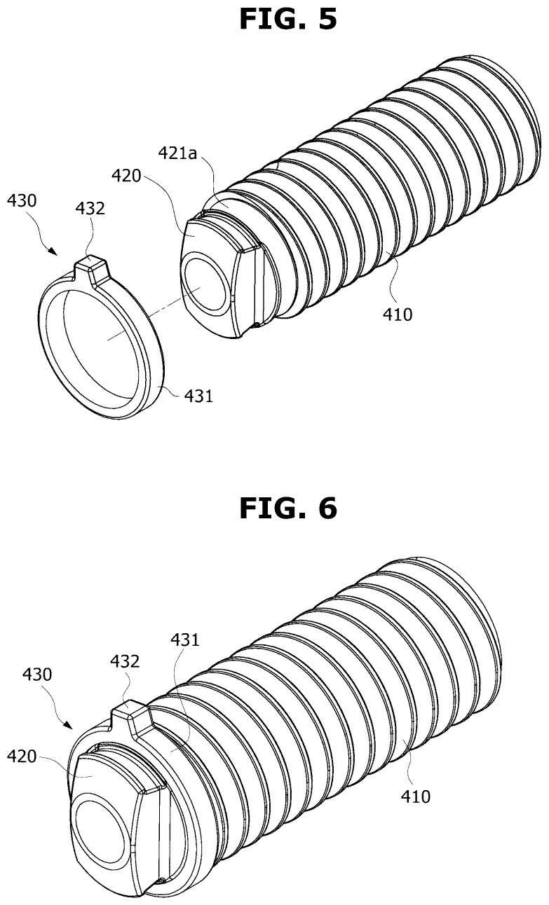

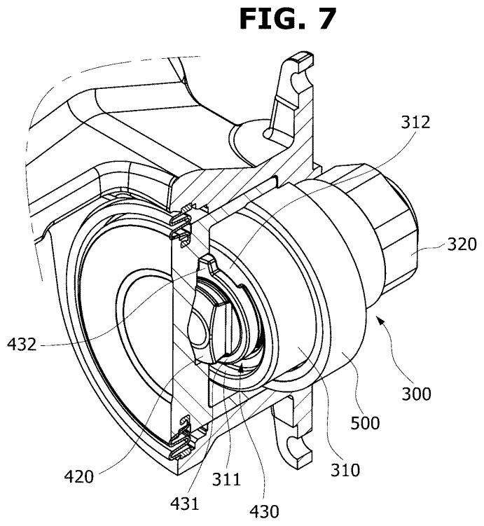

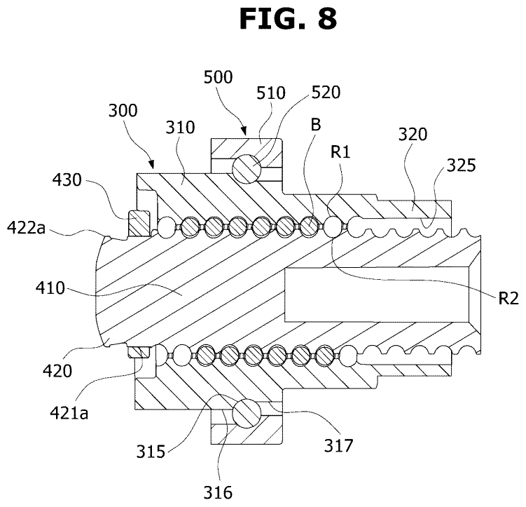

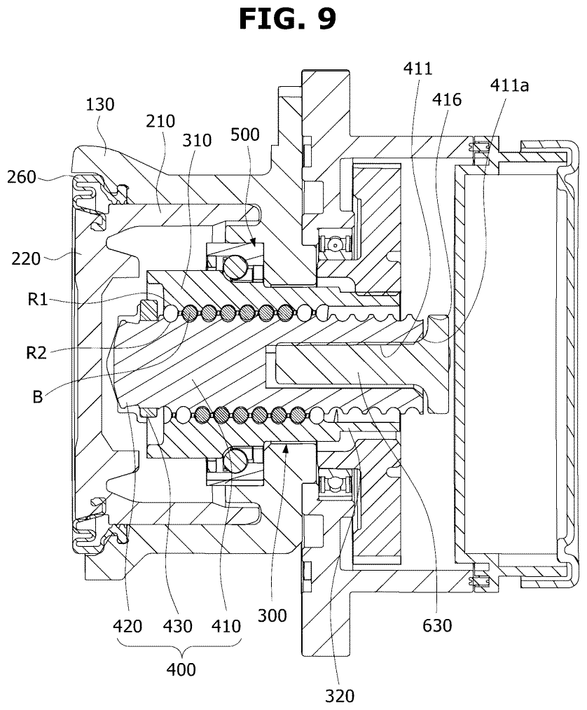

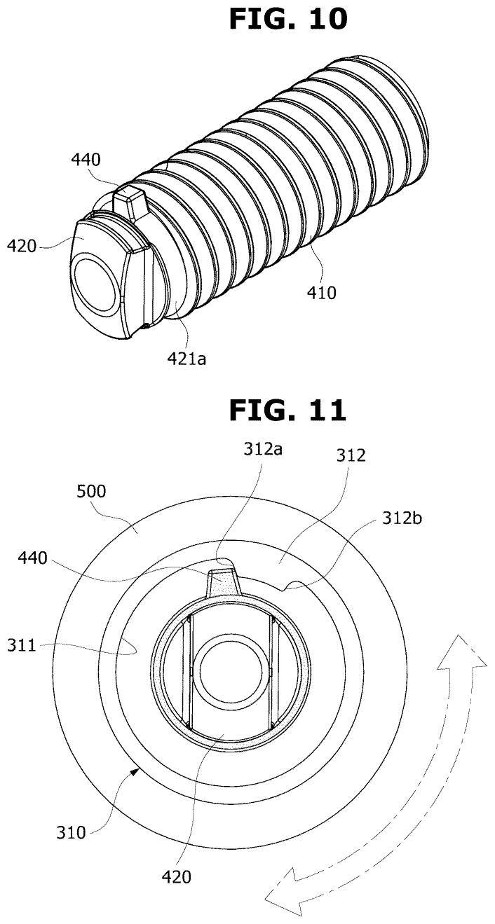

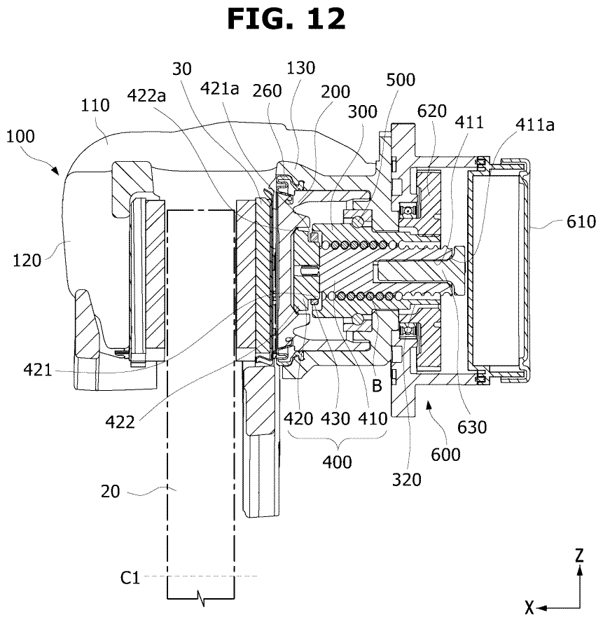

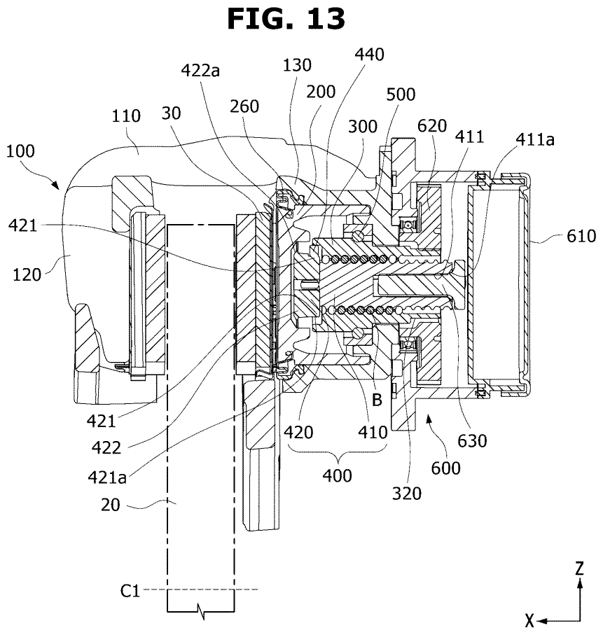

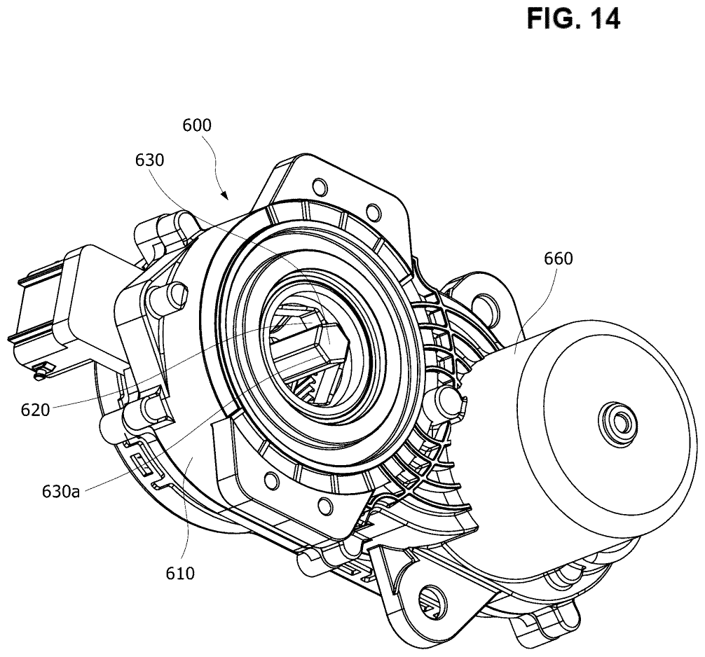

FIG. 1 is a perspective view illustrating a brake apparatus for a vehicle according to an embodiment of the present disclosure, FIG. 2 is a cross-sectional view schematically illustrating the brake apparatus for a vehicle according to the embodiment of the present disclosure, FIG. 3 is a perspective view illustrating a nut-screw part and a bolt-screw part according to the embodiment of the present disclosure, FIG. 4 is a front view illustrating the nut-screw part and the bolt-screw part according to the embodiment of the present disclosure, FIG. 5 is an exploded perspective view illustrating the bolt-screw part according to the embodiment of the present disclosure, FIG. 6 is a perspective view illustrating the bolt-screw part according to the embodiment of the present disclosure, FIG. 7 is a cross-sectional perspective view schematically illustrating the brake apparatus for a vehicle according to the embodiment of the present disclosure, FIG. 8 is a cross-sectional view illustrating the nut-screw part and the bolt-screw part according to the embodiment of the present disclosure, FIG. 9 is a cross-sectional view illustrating a cylinder, the nut-screw part, and the bolt-screw part according to the embodiment of the present disclosure, FIG. 10 is a perspective view illustrating a modified example of a bolt stopper of the brake apparatus for a vehicle according to the embodiment of the present disclosure, FIG. 11 is a front view illustrating the nut-screw part and the bolt-screw part to which the modified example of the bolt stopper is applied, FIG. 12 is a cross-sectional view schematically illustrating a brake apparatus for a vehicle according to another embodiment of the present disclosure, FIG. 13 is a cross-sectional view schematically illustrating a modified example of a bolt stopper of the brake apparatus for a vehicle according to another embodiment of the present disclosure, and FIG. 14 is a perspective view illustrating an actuator part of the brake apparatus for a vehicle according to the embodiment of the present disclosure.

With reference to FIGS. 1 to 11 and 14, a brake apparatus for a vehicle according to an embodiment of the present disclosure may include a caliper body 100, a piston part 200, a nut-screw part 300, and a bolt-screw part 400.

The caliper body 100 may define an external shape of the brake apparatus for a vehicle and surround or support the piston part 200, the nut-screw part 300, and the bolt-screw part 400.

The caliper body 100 may include a bridge 110, a finger 120, and a cylinder 130.

The bridge 110 may define an external appearance of a central portion of the caliper body 100 and support the finger 120 and the cylinder 130. The bridge 110 may be connected to a carrier (not illustrated) fixed to a knuckle (not illustrated) or the like by means of a guide rod (not illustrated).

A lower surface of the bridge 110 may be spaced apart from a peripheral surface of a brake disc 20 at a preset interval and disposed to face the peripheral surface of the brake disc 20. Two opposite sides of the bridge 110 may respectively extend in a first direction (a +X direction based on FIG. 2) and a second direction (a −X direction based on FIG. 2), which is a direction opposite to the first direction, based on the brake disc 20.

A pair of brake pads 30 may be disposed below the bridge 110. The pair of brake pads 30 may be disposed to face each other with the brake disc 20 interposed therebetween.

A friction pad, which includes a material, such as rubber, having a high frictional coefficient, may be attached to one surface of the brake pad 30 that faces the brake disc 20.

The finger 120 may extend downward from one side of the bridge 110. The finger 120 may be disposed to face any one of the pair of brake pads 30.

The cylinder 130 may extend downward from the other side of the bridge 110. The cylinder 130 may be formed in the shape of a column having a hollow portion therein. One side (a left side based on FIG. 2) of the cylinder 130 may be disposed to face the other of the pair of brake pads 30.

One side of the cylinder 130 may be open. One open side of the cylinder 130 may be spaced apart from the brake pad 30 at a preset interval, and the brake pad 30 may be spaced apart from the brake disc 20 in the second direction.

A central axis of the cylinder 130 may be disposed in parallel with a central axis C1 of the brake disc 20. The central axis of the cylinder 130 may be spaced apart from the central axis C1 of the brake disc 20 in a third direction (a +Z direction based on FIG. 2).

For example, the third direction may be a direction defined to be perpendicular to the first direction and the second direction and directed toward the central axis of the cylinder 130 from the central axis C1 of the brake disc 20.

In case that the lower surface of the bridge 110 is disposed in parallel with a ground surface, the third direction may be a direction that ascends in a direction perpendicular to the ground surface, i.e., in a Z-axis direction based on FIG. 2 from the ground surface.

The piston part 200 may be disposed in the cylinder 130 and configured to be movable in the first direction (the +X direction based on FIG. 2) or the second direction (the −X direction based on FIG. 2). The piston part 200 may be disposed inside the cylinder 130.

The piston part 200 may be formed in the shape of a column having a hollow portion therein. A side of the piston part 200, which is directed toward the brake pad 30, may be closed. The piston part 200 may be disposed in a longitudinal direction of the cylinder 130.

An outer surface of the piston part 200 may be slidably supported on an inner surface of the cylinder 130. On the contrary, the outer surface of the piston part 200 may be spaced apart from the inner surface of the cylinder 130 at a preset distance.

When the piston part 200 moves in the first direction, the piston part 200 may protrude to the outside of the cylinder 130 and press the brake pad 30, which is disposed to face the cylinder 130, toward the brake disc 20. Therefore, the brake apparatus for a vehicle may generate a braking force.

When the piston part 200 moves in the second direction, the piston part 200 may be spaced apart from the brake pad 30. Therefore, a pressing force applied to the brake pad 30 by the piston part 200 is released, and the braking force of the brake apparatus for a vehicle is eliminated.

The piston part 200 may include a piston body 210 and a piston head 220.

The piston body 210 is formed in the shape of a hollow column, and the piston head 220 is connected to the piston body 210 to close one side (a left side based on FIG. 2) of the piston body 210. The piston head 220 is disposed at one of two opposite open sides of the piston body 210, which is opposite to the brake pad 30, and closes an open region of the piston body 210.

The bolt-screw part 400 may be disposed inside the piston part 200. A bolt body 410 and a bolt head 420 of the bolt-screw part 400 are surrounded by the piston body 210. The bolt head 420 may be disposed and inserted into the piston head 220. Groove portions may be formed at two opposite left and right sides of the bolt head 420, and structures, which may be correspondingly assembled to the groove portions, may also be formed on the piston part 200, thereby improving coupling properties between the bolt head 420 and the piston part 200. The groove portion of the bolt head 420 may be formed by D-cut processing.

A piston boot 260 may be installed inside the cylinder 130 to prevent the introduction of external foreign substances and ensure watertightness in the cylinder 130. The piston boot 260 may be installed between the cylinder 130 and the piston part 200. The piston boot 260 may be coupled to the piston body 210 or the piston head 220 and press-fitted into the cylinder 130.

The piston boot 260 may be formed to surround the piston part 200. The piston boot 260 may include an elastically deformable material. For example, the piston boot 260 may be manufactured while including a rubber material. The piston boot 260 may be formed to have a corrugated shape.

The nut-screw part 300 may be rotatably disposed in the cylinder 130 and coupled to the bolt-screw part 400. A bearing part 500 may be installed inside the cylinder 130 and support the nut-screw part 300 so that the nut-screw part 300 is rotatable. The bearing part 500 may be a ball bearing disposed between the cylinder 130 and the nut-screw part 300.

The nut-screw part 300 may be formed in the shape of a column having a hollow portion therein and two opposite open ends. The nut-screw part 300 may be disposed inside the cylinder 130, and a central axis of the nut-screw part 300 may be positioned on the same axis as the central axis of the cylinder 130.

One side (a left side based on FIG. 2) of the nut-screw part 300 may be spaced apart from an inner surface (a right surface based on FIG. 2) of the piston part 200 at a preset interval and disposed to face the inner surface of the piston part 200. The other side (a right side based on FIG. 2) of the nut-screw part 300 may penetrate the cylinder 130 and protrude to the outside of the cylinder 130.

An inner surface of the nut-screw part 300 may be disposed to face an outer surface of the bolt-screw part 400. An outer ball rail R1 may be formed on the inner surface of the nut-screw part 300, and ball members B having spherical shapes may be seated on the outer ball rail R1. The outer ball rail R1 extends in a spiral shape in a longitudinal direction of the nut-screw part 300. The outer ball rail R1 of the nut-screw part 300, together with an inner ball rail R2 of the bolt-screw part 400 opposite to the outer ball rail R1, may define a circulation route for the ball members B.

When an actuator 600 operates, the nut-screw part 300 may receive a rotational force, which is generated from the actuator 600, through a power transmission part and rotate clockwise or counterclockwise about the central axis.

The nut-screw part 300 may include a nut-screw body 310 and a nut-screw tail 320.

Most of the nut-screw body 310 may be disposed in the cylinder 130, and the entirety or most of the nut-screw tail 320 may be exposed to the outside of the cylinder 130. The nut-screw body 310 may be surrounded by the piston body 210.

A rail hole portion and a through-hole portion 325 may be provided in an inner peripheral surface of the nut-screw part 300. The outer ball rail R1, on which the ball members B are seated, may be formed in a spiral shape in the longitudinal direction in the rail hole portion. The through-hole portion 325 may be a portion of the inner peripheral surface of the nut-screw part 300 in which the outer ball rail R1 is not formed.

The through-hole portion 325 may be formed along a circumference in an inner surface of the nut-screw tail 320. An inner diameter of the through-hole portion 325 is larger than a maximum outer diameter of the bolt body 410. Therefore, the bolt body 410 may move in the through-hole portion 325 when the nut-screw part 300 rotates.

An enlarged groove portion 311 may be provided in an inner surface of the nut-screw body 310. The enlarged groove portion 311 is a portion having a larger inner diameter than another inner surface of the nut-screw body 310 on which the outer ball rail R1 is formed (see FIGS. 4 and 8).

A nut stopper 312 is provided on the enlarged groove portion 311 and protrudes toward the bolt-screw part 400. The enlarged groove portion 311 is formed in a circular or approximately circular shape when viewed from the front side (based on FIG. 4), and the nut stopper 312 protrudes inward toward the bolt head 420 from one side of the enlarged groove portion 311. One nut stopper 312 may be formed on the enlarged groove portion 311.

The nut-screw tail 320 may be formed in the shape of a non-circular column. The non-circular shape refers to a shape that is not a perfectly circular shape, and the non-circular shape encompasses shapes such as an elliptical shape and a polygonal shape. In the present embodiment, the nut-screw tail 320 is formed in the shape of a polygonal column, specifically, an approximately hexagonal column.

The bolt-screw part 400 may move in the first direction and the second direction in the cylinder 130 in conjunction with the rotation of the nut-screw part 300. The bolt-screw part 400 may be disposed inside the nut-screw part 300. The bolt-screw part 400 may be disposed to penetrate two opposite ends of the nut-screw part 300.

The bolt-screw part 400 may move in the first direction, which is a direction directed toward the brake pad 30, and move the piston part 200 so that the piston part 200 presses the brake pad 30. In addition, the bolt-screw part 400 may move in the second direction that is a direction opposite to the first direction, thereby eliminating a pressing force applied to the piston part 200.

The bolt-screw part 400 may include the bolt body 410, the bolt head 420, and a bolt stopper 430.

The bolt body 410 may be coupled to the nut-screw part 300 and receive a rotational force from the nut-screw part 300. The bolt head 420 may be connected to the bolt body 410.

As illustrated in FIG. 8, the bolt head 420 may be manufactured integrally with the bolt body 410 without being provided as a member separated from the bolt body 410. Because the bolt body 410 and the bolt head 420 are integrally formed as a single member as described above, a manufacturing process may be simplified, costs may be reduced, and productivity may be improved.

In addition, the bolt-screw part 400 may be easily manufactured by performing rolling-processing on a round bar, which is continuous in a longitudinal direction, and then cutting the round bar into a required length. The bolt-screw part 400, which transmits a high load, has the bolt body 410, which is a portion on which the balls roll, and the bolt head 420 that are integrally formed so that the entire bolt-screw part 400 may be implemented with high rigidity. Further, the inner ball rail R2 may be formed on the bolt body 410, and the bolt head 420 may be additionally processed, such that the precision of the portion, on which the balls roll, may be improved, and the durability and operational reliability of the apparatus may be improved.

When the bolt body 410 translationally moves in the first direction in the cylinder 130 in conjunction with the rotation of the nut-screw part 300, the bolt head 420 disposed at a front side (a left side based on FIG. 2) of the bolt body 410 presses the piston part 200.

The bolt body 410 may be formed in the shape of a column having an approximately circular cross-section. The bolt body 410 may be disposed inside the cylinder 130, and a central axis of the bolt body 410 may be positioned on the same axis as the central axis of the cylinder 130. The bolt body 410 may be coupled to the nut-screw part 300 by means of the ball members B.

The inner ball rail R2, on which the ball members B are seated, may be formed on an outer peripheral surface of the bolt body 410. The inner ball rail R2 may extend in a spiral shape in a longitudinal direction (a leftward/rightward direction based on FIG. 2) of the bolt body 410 and provide a circulation route for the ball members B. Therefore, when the nut-screw part 300 rotates, the bolt body 410 may be moved in the first direction or the second direction by the circulation movement of the ball members B.

The outer ball rail R1, which is formed on the inner surface of the nut-screw part 300, and the inner ball rail R2, which is formed on the outer surface of the bolt body 410, may be disposed to face each other. An outer portion of the ball member B may be guided by the outer ball rail R1, and an inner portion of the ball member B may be guided by the inner ball rail R2, such that the ball member B may move in a spiral shape along the outer ball rail R1 and the inner ball rail R2.

The bolt head 420 may be disposed between the bolt body 410 and the piston part 200. The bolt head 420 may be formed to have an approximately circular cross-section. The bolt head 420 may be disposed and inserted into the piston head 220. The bolt head 420 may be spaced apart from an inner surface of the piston head 220 at a preset interval and disposed to face the inner surface of the piston head 220. The bolt head 420 may be disposed to be spaced apart from the piston head 220 in case that no braking force is generated by the brake apparatus for a vehicle or the braking force is eliminated.

The bolt head 420 may press the piston head 220. The bolt head 420 may press the piston head 220 in the first direction or release the piston head 220 depending on the movement direction of the bolt body 410. The rigidity of the bolt head 420 and the bolt body 410, which is formed with the inner ball rail R2, may be increased by heat treatment.

FIG. 8 illustrates that a diameter of the bolt head 420 is equal to or almost equal to a diameter of the bolt body 410. However, this configuration is merely illustrative, and the present disclosure is not limited thereto. That is, as illustrated in FIG. 12, a diameter of the bolt head 420 may be larger than a diameter of the bolt body 410 even in case that the bolt body 410 and the bolt head 420 are formed as a single member.

When the bolt head 420 is positioned at a rearmost point, the bolt stopper 430 or 440 may come into contact with the nut stopper 312 and suppress the rotation of the nut-screw part 300. The rearmost point of the bolt head 420 refers to a point at which the bolt-screw part 400 is positioned at a rearmost side within a maximum allowable stroke of the bolt-screw part 400. In case that the bolt head 420 is positioned at the rearmost point, no braking force is generated by the brake apparatus for a vehicle because the bolt head 420 is spaced apart from the piston part 200.

The contact between the bolt stopper 430 or 440 and the nut stopper 312 occurs in case that the bolt head 420 is positioned at the rearmost point. That is, the contact between the bolt stopper 430 or 440 and the nut stopper 312 occurs in a normal state in which a braking force is not yet generated by the brake apparatus for a vehicle or a state in which the bolt-screw part 400 returns to an original point (zero set) after the generated braking force is eliminated. Therefore, a relative position between the bolt stopper 430 or 440 and the nut stopper 312 may be set so that the nut stopper 312 comes into contact with the bolt stopper 430 or 440 in case that the bolt head 420 is positioned at the rearmost point. The original point may be called a zero point.

The rotation of the nut-screw part 300 is suppressed as the nut stopper 312 comes into contact with the bolt stopper 430 or 440, and a point, at which the rotation of the nut-screw part 300 is suppressed is a point identical to the original point of the bolt-screw part 400. Therefore, the bolt-screw part 400 may be configured to start the movement thereof always from the original point during the braking operation of the brake apparatus for a vehicle according to the embodiment of the present disclosure, thereby preventing the occurrence of a positional error and ensuring stable braking performance while the braking operation is performed.

When the braking force is eliminated, the bolt-screw part 400 completely returns to the original point, and the residual contact between the brake pad 30 and the brake disc 20 is removed, such that a zero drag state may be achieved. Therefore, unnecessary rotational resistance is removed while the vehicle travels, which may improve vehicle fuel economy, reduce abrasion of friction components, and improve durability and reliability of the braking system.

In case that the brake pad 30 is abraded, a stroke of the bolt-screw part 400 increases in proportion to the amount of abrasion. Because the bolt-screw part 400 starts the movement for the braking operation always from the original point, the amount of abrasion of the brake pad 30 may be accurately detected.

In addition, an air gap position may be periodically set each time the vehicle is turned on or off, such that the amount of abrasion of the brake pad 30 may be periodically detected as a numerical value based on information on rearmost and foremost positions of the bolt-screw part 400. In this case, the mechanical, permanent rearmost position of the bolt-screw part 400 may be ensured by means of the bolt stopper 430 or 440. The air gap position may be identical to a load generation point, or the air gap position may be a position spaced apart from the load generation point at a predetermined distance. For example, the air gap position may be a point 0 to 1 mm behind the load generation point.

In case that the bolt head 420 is positioned in the vicinity of the rearmost point, the enlarged groove portion 311 and the bolt head 420 are disposed to be opposite to each other. The bolt stopper 430 or 440 protrudes outward further than an outer surface of the bolt head 420 so that the bolt stopper 430 or 440 may come into contact with the nut stopper 312 protruding from the enlarged groove portion 311.

One embodiment of the bolt stopper 430 will be described with reference to FIGS. 3 to 6. The bolt stopper 430 may include a ring main body 431 and a ring protrusion 432.

The ring main body 431 may be coupled to an outer surface 421a of the bolt head 420 by press-fitting, interference-fitting, serration coupling, or the like. The ring protrusion 432 may protrude outward from an outer surface of the ring main body 431 and come into contact with the nut stopper 312.

When the nut-screw part 300 further rotates counterclockwise in the state illustrated in FIG. 4, the ring protrusion 432, which is positioned in a rotation route for the nut stopper 312, comes into contact with the nut stopper 312, such that the counterclockwise rotation of the nut-screw part 300 is suppressed, and the rearward movement of the bolt-screw part 400 is also suppressed. In this case, the bolt-screw part 400 reaches (is positioned at) the rearmost point. The contact between the nut stopper 312 and the ring protrusion 432 occurs at one side 312a of the nut stopper 312.

During the process in which the braking force is generated, the nut-screw part 300 moves the bolt-screw part 400 forward while rotating clockwise. When the nut-screw part 300 rotates clockwise at a predetermined angle or more in comparison with the state illustrated in FIG. 4, the ring protrusion 432 may depart from the rotation route for the nut stopper 312.

Therefore, the contact between the other side 312b of the nut stopper 312 and the ring protrusion 432 does not occur during the process in which the braking force is generated or eliminated. Therefore, the contact between the nut stopper 312 and the ring protrusion 432 does not occur, except for the case in which the bolt head 420 is positioned at the rearmost point.

One nut stopper 312 and one ring protrusion 432 may be provided so that the nut stopper 312 and the ring protrusion 432 come into contact with each other when the bolt head 420 is positioned at the rearmost point.

A lateral portion of a protruding portion of the bolt stopper 430 and a lateral portion of a protruding portion of the nut stopper 312 may each have an inclined surface. With reference to FIG. 4, the lateral portion of the ring protrusion 432 and one side 312a of the nut stopper 312 may each be formed to have an inclined surface. Therefore, one side 312a of the nut stopper 312 may come into surface contact with the lateral portion of the ring protrusion 432, such that the rotation of the nut stopper 312 may be more securely suppressed, and a load may be prevented from being concentrated at a specific point of the nut stopper 312 and a specific point of the ring protrusion 432.

Another embodiment of the bolt stopper 440 will be described with reference to FIGS. 10 and 11.

The bolt stopper 440 may be coupled to the outer surface 421a of the bolt head 420 by press-fitting, interference-fitting, serration coupling, or the like. The bolt stopper 440 may protrude outward from the outer surface 421a and come into contact with the nut stopper 312. The bolt stopper 440 may include a spring pin disposed in a direction perpendicular to or approximately perpendicular to an axis of the bolt head 420.

When the nut-screw part 300 further rotates counterclockwise in the state illustrated in FIG. 11, the bolt stopper 440, which is positioned in the rotation route for the nut stopper 312, comes into contact with the nut stopper 312, such that the counterclockwise rotation of the nut-screw part 300 is suppressed, and the rearward movement of the bolt-screw part 400 is also suppressed. In this case, the bolt-screw part 400 reaches (is positioned at) the rearmost point. The contact between the nut stopper 312 and the bolt stopper 440 occurs at one side 312a of the nut stopper 312.

During the process in which the braking force is generated, the nut-screw part 300 moves the bolt-screw part 400 forward while rotating clockwise. The bolt stopper 440 may depart from the rotation route for the nut stopper 312 before the nut-screw part 300 rotates clockwise at a predetermined angle, for example, performs a half turn in comparison with the state illustrated in FIG. 11.

Therefore, the contact between the other side 312b of the nut stopper 312 and the bolt stopper 440 does not occur during the process in which the braking force is generated or the braking force is eliminated. The contact between the nut stopper 312 and the bolt stopper 440 does not occur as long as the bolt head 420 is not positioned at the rearmost point.

One nut stopper 312 and one bolt stopper 440 may be provided so that the nut stopper 312 and the bolt stopper 440 come into contact with each other when the bolt head 420 is positioned at the rearmost point.

A lateral portion of a protruding portion of the bolt stopper 440 and the lateral portion of the protruding portion of the nut stopper 312 may each have an inclined surface. With reference to FIG. 11, the lateral portion of the bolt stopper 440 and one side 312a of the nut stopper 312 may each be formed to have an inclined surface. Therefore, one side 312a of the nut stopper 312 may come into surface contact with the lateral portion of the bolt stopper 440, such that the rotation of the nut stopper 312 may be more securely suppressed, and a load may be prevented from being concentrated at a specific point of the nut stopper 312 and a specific point of the bolt stopper 440.

A curved portion 422a may be provided on an outer periphery of the bolt head 420 directed toward the piston head 220. The curved surface portion 422a may be formed as a curved surface having a shape convex toward the piston head 220 and formed over the entire outer periphery of the bolt head 420. The curved surface portion 422a of the bolt head 420 may come into contact with the piston head 220.

The curved surface portion 422a of the bolt head 420 may come into rollable contact with the piston head 220. That is, the curved surface portion 422a of the bolt head 420 may roll relative to the piston head 220.

A flat surface portion may be provided on a portion of the piston head 220 that adjoins the curved surface portion 422a. Therefore, the bolt head 420, which has the convex curved surface portion 422a, and the piston head 220, which has the flat surface portion, may be maintained to be in contact with each other even though the bolt head 420 rolls relative to the piston head 220 in case that the bolt head 420 is brought into contact with the piston head 220 by the movement of the bolt-screw part 400 in the first direction.

With reference to FIGS. 1 to 11, in case that the braking force is generated by friction between the brake disc 20 and the brake pad 30 generated by the movement of the piston 200, a shape of the caliper body 100 may be partially deformed by a reaction of the braking force. Therefore, the cylinder 130 and the piston 200 may be slightly inclined with respect to the central axis in comparison with a non-braked state. That is, in a braked state, the cylinder 130 and/or the piston 200 may be tilted at a minute angle with respect to the central axis.

In case that the cylinder 130 and/or the piston 200 is tilted with respect to the central axis, the curved surface portion 422a of the bolt head 420 may come into rollable contact with the piston head 220. That is, in case that the cylinder 130 and/or the piston 200 is tilted with respect to the central axis, the curved surface portion 422a may roll relative to the piston head 220.

Because the bolt head 420 rolls relative to the piston head 220 when the cylinder 130 and/or the piston 200 is tilted with respect to the central axis, the bolt body 410, which is coupled to the bolt head 420, is also inclined by an angle at which the bolt head 420 is inclined while rolling.

Because the bolt head 420 and the bolt body 410 are also inclined when the cylinder 130 and/or the piston 200 is inclined with respect to the central axis as described above, it is possible to prevent a load from being concentrated only on a specific ball member B among the plurality of ball members B disposed in the longitudinal direction of the bolt body 410. Therefore, it is possible to ensure the durability of the bolt-screw part 400 against the tilting of the cylinder 130 and/or the piston 200, thereby improving the durability of the brake apparatus for a vehicle.

The bearing part 500 may be disposed between the cylinder 130 and the nut-screw part 300 and support the nut-screw part 300 so that the nut-screw part 300 is rotatable inside the cylinder 130.

In case that the cylinder 130 and/or the piston 200 is tilted with respect to the central axis, the nut-screw part 300 may come into rollable contact with the bearing part 500. That is, in case that the cylinder 130 and/or the piston 200 is tilted with respect to the central axis, the nut-screw part 300 may roll relative to the bearing part 500.

Because the nut-screw part 300 is also inclined when the cylinder 130 and/or the piston 200 are inclined with respect to the central axis as described above, it is possible to prevent a load of the nut-screw part 300 from being concentrated only on a specific ball member B among the plurality of ball members B disposed in the longitudinal direction of the bolt body 410. Therefore, it is possible to ensure the durability of the bolt-screw part 400 against the tilting of the cylinder 130 and/or the piston 200, thereby improving the durability of the brake apparatus for a vehicle.

The bearing part 500 may include an outer race part 510 and bearing balls 520.

The outer race part 510 is in contact with the inner surface of the cylinder 130. The outer race part 510 may be coupled to the cylinder 130 by press-fitting, such that a position of the outer race part 510 may be securely fixed. The bearing balls 520 may be disposed between the outer race part 510 and the nut-screw body 310. In the present embodiment, the nut-screw body 310 is exemplified as serving as the inner race part, but the inner race part may, of course, be formed integrally with the nut-screw body 310 as in the present embodiment. The inner race part may be formed separately from the nut-screw body 310.

The nut-screw body 310 may include a rolling contact portion 315, an upper stepped portion 316, and a lower bottom portion 317.

Because the nut-screw body 310 serves as the inner race part that is a rotatable part of the bearing part 500, the nut-screw body 310 may rotate relative to the outer race part 510. In addition, because the rolling contact portion 315 is provided on the portion of the nut-screw body 310 that is opposite to the bearing balls 520, the nut-screw body 310 may roll relative to the bearing balls 520. Because the nut-screw body 310 may roll relative to the bearing balls 520, an angle between the nut-screw body 310 and the outer race part 510 may be changed.

Based on the rolling contact portion 315, the upper stepped portion 316 of the nut-screw body 310 may be formed adjacent to the piston head 220, and the lower bottom portion 317 may be formed adjacent to the nut-screw tail 320. The upper stepped portion 316 may be a portion protruding outward further than the lower bottom portion 317, and the rolling contact portion 315 may be formed between the upper stepped portion 316 and the lower bottom portion 317.

The rolling contact portion 315 may be formed as a curved surface having a shape concave inward and formed over the entire outer periphery of the nut-screw body 310. The bearing balls 520 may be in direct contact with the rolling contact portion 315 or indirect contact with the rolling contact portion 315 by means of another member.

Because the rolling contact portion 315 is provided with the curved surface portion, the rolling contact portion 315 of the nut-screw body 310 may roll relative to the bearing balls 520 or the outer race part 510.

During the braking operation of the brake apparatus for a vehicle, the piston part 200 may be tilted with respect to the central axis or the cylinder 130 may be tilted with respect to the central axis by braking torque or the opening of the caliper body 100. According to the present embodiment, the bolt head 420 may roll relative to the piston part 200, thereby preventing a load from being concentrated only on a specific ball member B among the plurality of ball members B disposed on the outer surface of the bolt-screw part 400. In addition, according to the present embodiment, the nut-screw part 300 may roll relative to the bearing part 500, thereby preventing a load from being concentrated only on a specific ball member B among the plurality of ball members B disposed on the inner surface of the nut-screw part 300.

The brake apparatus for a vehicle according to the present embodiment may allow the rolling motion on a front portion of the bolt-screw part 400, an outer portion of the nut-screw part 300, or both the front portion of the bolt-screw part 400 and the outer portion of the nut-screw part 300, thereby preventing a concentrated load from being applied to the specific ball member B even in case that the piston part 200 is tilted with respect to the central axis or the cylinder 130 is tilted with respect to the central axis. Therefore, the brake apparatus for a vehicle according to the present embodiment may improve the durability of the apparatus while ensuring the durability against the tilting.

FIG. 12 is a cross-sectional view schematically illustrating a brake apparatus for a vehicle according to another embodiment of the present disclosure, and FIG. 13 is a cross-sectional view schematically illustrating a modified example of a bolt stopper of the brake apparatus for a vehicle according to another embodiment of the present disclosure.

The brake apparatus for a vehicle according to the embodiment of the present disclosure illustrated in FIGS. 1 to 11, in which the bolt body 410 and the bolt head 420 are integrally formed as a single member, is substantially identical in structures, operations, and the like to the brake apparatus for a vehicle according to another embodiment of the present disclosure illustrated in FIGS. 12 and 13, except that the bolt body 410 and the bolt head 420 are formed as separate members and coupled to each other. Therefore, a repetitive description will be omitted.

With reference to FIGS. 12 and 13, the bolt head 420 may be provided separately from the bolt body 410. The bolt body 410 may be integrated with and coupled to the bolt head 420 by press-fitting. For example, the bolt body 410 may be coupled to the bolt head 420 by serration press-fitting. Because the bolt head 420 is manufactured separately from the bolt body 410, it is possible to improve shape flexibility of the bolt head 420. The shape of the bolt head 420 may change depending on the specifications and the like of the brake apparatus for a vehicle. Because the bolt head 420 is formed separately from the bolt body 410 that may be relatively easily standardized, the bolt head 420 may be easily customized, and the degree of design freedom may be improved. According to the present embodiment, in case that a size of the piston 200 is changed, a contact diameter of the bolt head 420 may be easily changed in accordance with the size of the piston 200.

An outer diameter of the bolt head 420 may be larger than an outer diameter of the bolt body 410. Therefore, the contact diameter of the bolt head 420, which comes into contact with the piston head 220 when the bolt-screw part 400 moves the piston part 200 toward the brake pad 30 by pressing the piston part 200, may be further increased, thereby improving efficiency in transmitting a load to the piston part 200 through the bolt head 420. In addition, because the contact diameter of the bolt head 420, which comes into contact with the piston head 220, is increased, it is possible to stably transmit a load to the piston part 200 and stably maintain centering of the bolt-screw part 400.

FIGS. 12 and 13 illustrate that a diameter of the bolt head 420 is larger than a diameter of the bolt body 410. However, the present disclosure is not limited thereto. That is, as illustrated in FIG. 8, a diameter of the bolt head 420 may be equal to or smaller than a diameter of the bolt body 410 even in case that the bolt body 410 and the bolt head 420 are formed as separate members.

The bolt head 420 may include a head connection portion 421 and a head enlarged portion 422.

The head connection portion 421 is a portion directed toward the bolt body 410 from the bolt head 420, and the head connection portion 421 is connected to the bolt body 410. The head enlarged portion 422 may extend toward the piston head 210 from the head connection portion 421 and have an outer diameter larger than an outer diameter of the head connection portion 421. Therefore, it is possible to increase the contact diameter of the bolt-screw part 400 that comes into contact with the piston part 200.

In case that an outer diameter of the head enlarged portion 422, which comes into contact with the piston head 220, is larger than an outer diameter of the head connection portion 421, the contact diameter by which the head enlarged portion 422 comes into contact with the piston head 220 may be increased in comparison with a case in which the outer diameter of the head enlarged portion 422 and the outer diameter of the head connection portion 421 are equal to each other, thereby further improving efficiency in transmitting a load to the piston part 200 through the bolt head 420. In addition, because the contact diameter of the head enlarged portion 422, which comes into contact with the piston head 220, is increased, the load may be more stably transmitted to the piston part 200.

The curved surface portion 422a may be provided on the outer periphery of the head enlarged portion 422 directed toward the piston head 220. The curved surface portion 422a may be formed as a curved surface having a shape convex toward the piston head 220 and formed over the entire outer periphery of the head enlarged portion 422. The curved surface portion 422a of the head enlarged portion 422 may come into contact with the piston head 220.

The curved surface portion 422a of the head enlarged portion 422 may come into rollable contact with the piston head 220. That is, the curved surface portion 422a of the head enlarged portion 422 may roll relative to the piston head 220.

A flat surface portion may be provided on a portion of the piston head 220 that adjoins the curved surface portion 422a. Therefore, the head enlarged portion 422, which has the convex curved surface portion 422a, and the piston head 220, which has the flat surface portion, may be maintained to be in contact with each other even though the head enlarged portion 422 rolls relative to the piston head 220 in case that the head enlarged portion 422 is brought into contact with the piston head 220 by the movement of the bolt-screw part 400 in the first direction.

In case that the braking force is generated by friction between the brake disc 20 and the brake pad 30 generated by the movement of the piston 200, a shape of the caliper body 100 may be partially deformed by a reaction of the braking force. Therefore, the cylinder 130 and the piston 200 may be slightly inclined with respect to the central axis in comparison with the non-braked state. That is, in the braked state, the cylinder 130 and/or the piston 200 may be tilted at a minute angle with respect to the central axis.

In case that the cylinder 130 and/or the piston 200 is tilted with respect to the central axis, the curved surface portion 422a of the head enlarged portion 422 may come into rollable contact with the piston head 220. That is, in case that the cylinder 130 and/or the piston 200 is tilted with respect to the central axis, the curved surface portion 422a of the head enlarged portion 422 may roll relative to the piston head 220.

Because the head enlarged portion 422 rolls relative to the piston head 220 when the cylinder 130 and/or the piston 200 is tilted with respect to the central axis, the bolt body 410, which is coupled to the bolt head 420, is also inclined by an angle at which the bolt head 420 is inclined while rolling.

Because the bolt head 420 and the bolt body 410 are also inclined when the cylinder 130 and/or the piston 200 is inclined with respect to the central axis as described above, it is possible to prevent a load from being concentrated only on a specific ball member B among the plurality of ball members B disposed in the longitudinal direction of the bolt body 410. Therefore, it is possible to ensure the durability of the bolt-screw part 400 against the tilting of the cylinder 130 and/or the piston 200, thereby improving the durability of the brake apparatus for a vehicle.

With reference to FIG. 12, the bolt stopper 430 may include the ring main body 431 and the ring protrusion 432. The ring main body 431 may be coupled to the bolt head 420, more specifically, the outer surface 421a of the head connection portion 421 by press-fitting, interference-fitting, serration coupling, or the like. The ring protrusion 432 may protrude outward from the outer surface of the ring main body 431 and come into contact with the nut stopper 312. Hereinafter, the structure and operation of the bolt stopper 430 of the brake apparatus for a vehicle according to another embodiment of the present disclosure are substantially identical to those of the bolt stopper 430 of the brake apparatus for a vehicle according to the embodiment of the present disclosure. Therefore, a repetitive description will be omitted.

With reference to FIG. 13, the bolt stopper 440 may be coupled to the bolt head 420, more specifically, the outer surface 421a of the head connection portion 421 by press-fitting, interference-fitting, serration coupling, or the like. The bolt stopper 440 may protrude outward from the outer surface 421a of the head connection portion 421 and come into contact with the nut stopper 312. The bolt stopper 440 may include the spring pin disposed in the direction perpendicular to or approximately perpendicular to the axis of the bolt head 420. Hereinafter, the structure and operation of the bolt stopper 440 of the brake apparatus for a vehicle according to another embodiment of the present disclosure are substantially identical to those of the bolt stopper 440 of the brake apparatus for a vehicle according to the embodiment of the present disclosure. Therefore, a repetitive description will be omitted.

With reference to FIG. 14, the brake apparatus for a vehicle according to the embodiment of the present disclosure may further include an actuator part 600.

The actuator part 600 may receive power from a motor part 660 and provide a rotational force to the nut-screw part 300.

The actuator part 600 may be provided with a power transmission part. The power transmission part may engage with the nut-screw part 300 and transmit the rotational force to the nut-screw part 300. The bolt-screw part 400 may translationally move as the nut-screw part 300 is rotated by the rotational force provided from the actuator part 600.

The present embodiment provides a nut-screw-driven-type brake apparatus for a vehicle in which the nut-screw part 300 rotates first by receiving the rotational force from the actuator 600, and the bolt-screw part 400, which is power-connected to the nut-screw part 300 by the ball members B, subsequently moves translationally. Therefore, according to the present embodiment, an axial length may be decreased in comparison with a bolt-screw-driven-type brake apparatus for a vehicle.

The power transmission part may include a plurality of gears coupled while sequentially engaging between the motor part 660 and the nut-screw part 300. The power transmission part is not limited to the above-mentioned configuration. The power transmission part may be designed and modified as various types of power transmission means capable of rotating the nut-screw part 300 by receiving the rotational force from the motor part 660.

The power transmission part may include a power transmission groove portion 620 disposed in an actuator housing 610.

The power transmission groove portion 620 may be disposed to surround a rotation prevention protrusion 630 and inserted into the nut-screw tail 320 of the nut-screw part 300.

The power transmission groove portion 620 may be formed in a shape corresponding to the nut-screw tail 320 so that the power transmission groove portion 620 engages with the nut-screw tail 320. The power transmission groove portion 620 may be formed as a non-circular groove portion. The non-circular shape refers to a shape that is not a perfectly circular shape, and the non-circular shape encompasses shapes such as an elliptical shape and a polygonal shape. In the present embodiment, the power transmission groove portion 620 is formed as a polygonal groove portion, specifically, an approximately hexagonal groove portion.

The nut-screw tail 320 and the power transmission groove portion 620 may each be formed in a non-circular shape and formed in the same shape or the corresponding shape. Therefore, the nut-screw tail 320 and the power transmission groove portion 620 engage with each other in case that the nut-screw tail 320 is inserted into the power transmission groove portion 620. Therefore, when the power transmission groove portion 620 rotates when the actuator 600 operates, the nut-screw tail 320, which engages with the power transmission groove portion 620, also rotates in the same direction. Therefore, the rotational force of the actuator 600 may be stably transmitted to the nut-screw part 300 without being lost.

The actuator part 600 may be provided with a rotation prevention portion. The rotation prevention portion may engage with the bolt-screw part 400 and restrict the rotation of the bolt-screw part 400. The bolt-screw part 400 moves translationally as the nut-screw part 300 is rotated by the rotational force provided from the actuator part 600.

Because the nut-screw part 300 and the bolt-screw part 400 are power-coupled by the ball members B, the rotation of the bolt-screw part 400 is suppressed by the rotation prevention portion so that the rotation of the nut-screw part 300 is converted into the translational movement of the bolt-screw part 400.

The rotation prevention portion may include the rotation prevention protrusion 630. The rotation prevention protrusion 630 may be disposed in the actuator housing 610 and protrude to the outside of the actuator housing 610. The rotation prevention protrusion 630 may be disposed inside the power transmission groove portion 620.

When the nut-screw tail 320 is inserted into and engages with the power transmission groove portion 620, the rotation prevention protrusion 630 may be inserted into and engage with a rotation prevention groove portion 411 of the bolt body 410. As described above, according to the present embodiment, the transmission of power to the nut-screw part 300 and the prevention of the rotation of the bolt-screw part 400 may be implemented by one assembling process, thereby significantly improving assemblability.

The rotation prevention protrusion 630 may be formed in the shape of a non-circular column. The non-circular shape refers to a shape that is not a perfectly circular shape, and the non-circular shape encompasses shapes such as an elliptical shape and a polygonal shape. In the present embodiment, the rotation prevention protrusion 630 is formed in the shape of a polygonal column, specifically, an approximately hexagonal column.

The rotation prevention groove portion 411 may be formed in the bolt body 410 and have a shape corresponding to the rotation prevention protrusion 630 so that the rotation prevention groove portion 411 engages with the rotation prevention protrusion 630. The rotation prevention groove portion 411 may be formed as a non-circular groove portion. The non-circular shape refers to a shape that is not a perfectly circular shape, and the non-circular shape encompasses shapes such as an elliptical shape and a polygonal shape. In the present embodiment, the rotation prevention groove portion 411 is formed as a polygonal groove portion, specifically, an approximately hexagonal groove portion.

The rotation prevention protrusion 630 and the rotation prevention groove portion 411 may each be formed in a non-circular shape and formed in the same shape or the corresponding shape. Therefore, in case that the rotation prevention protrusion 630 is inserted into the rotation prevention groove portion 411, the rotation prevention protrusion 630 and the rotation prevention groove portion 411 engage with each other. Therefore, when the power transmission groove portion 620 rotates when the actuator 600 operates, the nut-screw tail 320, which engages with the power transmission groove portion 620, rotates in the same direction, but the rotation of the bolt body 410 is suppressed. Therefore, the rotational force of the actuator 600 may be stably converted into the translational movement of the bolt-screw part 400 without being lost.

Because the rotation prevention protrusion 630 and the rotation prevention groove portion 411 come into surface contact with each other, a loss of frictional force may be reduced and the centering of the bolt body 410 may be maintained when an axial forward load is generated. In addition, because the rotation prevention groove portion 411 may be formed integrally with the bolt body 410, a rotation prevention structure does not need to be separately manufactured. Therefore, the spatial utilization may be improved.

The rotation prevention groove portion 411 may be provided with an enlarged inclined surface 411a enlarged outward to guide the proper insertion of the rotation prevention protrusion 630. A tapered inclined surface portion 630a may be provided at an outer side of a leading end portion of the rotation prevention protrusion 630 so that the rotation prevention protrusion 630 may be more easily inserted into the rotation prevention groove portion 411.

A length, by which the rotation prevention protrusion 630 is inserted into the bolt body 410, may be larger than a maximum stroke of the piston part 200. The maximum stroke of the piston part 200 refers to a distance by which the piston part 200 moves from the original point to a maximum forward point. The stroke of the piston part 200 may be increased by the amount of abrasion when the brake pad 30 is abraded. Therefore, because the length by which the rotation prevention protrusion 630 is inserted into the bolt body 410 is larger than the maximum stroke of the piston part 200, the rotation prevention protrusion 630 may be maintained to always engage with the rotation prevention groove portion 411 of the bolt body 410, and the rotation of the bolt-screw part 400 may always be suppressed.

While the present disclosure has been described with reference to the embodiments depicted in the drawings, the embodiments are for illustrative purposes only, and those skilled in the art to which the present technology pertains will understand that various modifications of the embodiments and any other embodiments equivalent thereto are available. Accordingly, the true technical protection scope of the present disclosure should be determined by the appended claims.

Although exemplary embodiments of the disclosure have been disclosed for illustrative purposes, those skilled in the art will appreciate that various modifications, additions and substitutions are possible, without departing from the scope and spirit of the disclosure as defined in the accompanying claims. Thus, the true technical scope of the disclosure should be defined by the following claims.

1. A brake apparatus for a vehicle, the brake apparatus comprising:
a caliper body provided with a cylinder;
a piston part movably disposed in the cylinder and disposed to be opposite to a brake pad;
a nut-screw part disposed in the piston part and configured to rotate by receiving a rotational force from an actuator; and
a bolt-screw part comprising a bolt body coupled to the nut-screw part and configured to receive rotational force from the nut-screw part, a bolt head disposed to be opposite to the piston part, and a bolt stopper configured to suppress a rotation of the nut-screw part when the bolt head is positioned at a rearmost point.

2. The brake apparatus of claim 1, wherein a nut stopper is provided on an inner surface of the nut-screw part and protrudes toward the bolt-screw part, and the bolt stopper protrudes outward further than an outer surface of the bolt head.

3. The brake apparatus of claim 2, wherein the bolt stopper is disposed in a rotation route for the nut stopper and suppresses a rotation of the nut stopper when the bolt head is positioned at the rearmost point, and
wherein the bolt stopper departs from the rotation route for the nut stopper to allow the rotation of the nut stopper when the bolt head departs from the rearmost point.

4. The brake apparatus of claim 3, wherein the bolt stopper comprises:
a ring main body coupled to the outer surface of the bolt head; and
a ring protrusion protruding outward from an outer surface of the ring main body and configured to come into contact with the nut stopper.

5. The brake apparatus of claim 3, wherein the bolt stopper is coupled to the outer surface of the bolt head and protrudes outward so as to be capable of coming into contact with the nut stopper.

6. The brake apparatus of claim 4, wherein the bolt stopper and the nut stopper are respectively provided as one bolt stopper and one nut stopper.

7. The brake apparatus of claim 4, wherein a lateral portion of a protruding portion of the bolt stopper and a lateral portion of a protruding portion of the nut stopper each have an inclined surface.

8. The brake apparatus of claim 1, wherein the bolt head is a single member formed integrally with the bolt body.

9. The brake apparatus of claim 1, wherein the bolt head is provided separately from the bolt body and integrated with the bolt body by being coupled to the bolt body.

10. The brake apparatus of claim 8, wherein a curved surface portion is provided on an outer periphery of the bolt head directed toward the piston part, and the curved surface portion is in contact with the piston part.

11. The brake apparatus of claim 5, wherein the bolt stopper and the nut stopper are respectively provided as one bolt stopper and one nut stopper.

12. The brake apparatus of claim 5, wherein a lateral portion of a protruding portion of the bolt stopper and a lateral portion of a protruding portion of the nut stopper each have an inclined surface.

13. The brake apparatus of claim 9, wherein a curved surface portion is provided on an outer periphery of the bolt head directed toward the piston part, and the curved surface portion is in contact with the piston part.
